(19) United States
(12) Patent Application Publication
(10) Pub. No.: US 2008/0120165 A1
(43) Pub. Date: May 22, 2008

(54) Large-Scale Aggregating and Reporting of Ad Data

(75) Inventor: Weipeng Yan, Redwood City, CA (US)

Correspondence Address: FISH & RICHARDSON P.C., PO BOX 1022, MINNEAPOLIS, MN, 55440-1022, US

(73) Assignee: Google Inc., Mountain View, CA (US)

(21) Appl. No.: 11/561,869

(22) Filed: Nov. 20, 2006

(51) Int. Cl. G06Q 30/00

(52) U.S. Cl. 705/10; 705/1; 705/14

(57) ABSTRACT

Statistical data relating to one or more parameters associated with an advertisement may be gathered. The statistical data may be filtered to a Universal Resource Locator (URL) or domain level. The statistical data may be aggregated and evaluated, including applying a filter to the statistical data. The filtered data may be delivered to an advertiser. The advertiser may receive the filtered data in a report and modify their advertising campaign in accordance with the report.

### BACKGROUND

This disclosure relates generally to online advertising.

In online advertising, some advertisers may advertise on multiple websites, advertise in various parts of the world, and have many different types of advertisements (e.g., text, video). Advertisers want to have statistical reports that provide useful information, so that they can adjust their advertising campaigns, e.g., reduce advertising on websites or from regions that are not producing the desired results, changing the type of advertisement (“ad”), and so forth. To eliminate unproductive websites, advertisers need to have reports that provide location information relating to the locations where their advertisements are being displayed, such as Universal Resource Locator (URL)/domain information. At the same time, large-scale online advertising can generate a large amount of raw data. Gathering such data and generating reports on a large scale can consume much time and computing resources.

### SUMMARY

According to one aspect, a method includes gathering statistical data relating to one or more parameters associated with an advertisement, including filtering the statistical data to a Universal Resource Locator (URL) or domain level; and delivering the statistical data to an advertiser. Other implementations of this aspect include corresponding systems, apparatus, and computer readable mediums.

According to one aspect, a method includes aggregating statistical data relating to one or more parameters associated with an advertisement; evaluating the statistical data, including applying a filter to the statistical data; and delivering the filtered statistical data to an advertiser. Other implementations of this aspect include corresponding systems, apparatus, and computer readable mediums.

According to one aspect, a method includes receiving a report comprising statistical data associated with an advertisement placement in an advertising campaign, the statistical data filtered to a URL or domain level; and modifying the advertising campaign in accordance with the report. Other implementations of this aspect include corresponding systems, apparatus, and computer readable mediums.

### BRIEF DESCRIPTION OF THE DRAWINGS

FIG. 1 is a block diagram illustrating an exemplary online advertising data aggregation and reporting system.

FIG. 2 is a flow diagram illustrating an exemplary process for collecting and processing advertising data.

FIG. 3 is a flow diagram illustrating an exemplary process for reducing and reporting advertising data.

FIG. 4 illustrates an exemplary advertisement data report.

FIG. 5 is a block diagram illustrating an exemplary system architecture for an online advertising data aggregation and reporting system.

Like reference numbers and designations in the various drawings indicate like elements.

### DETAILED DESCRIPTION

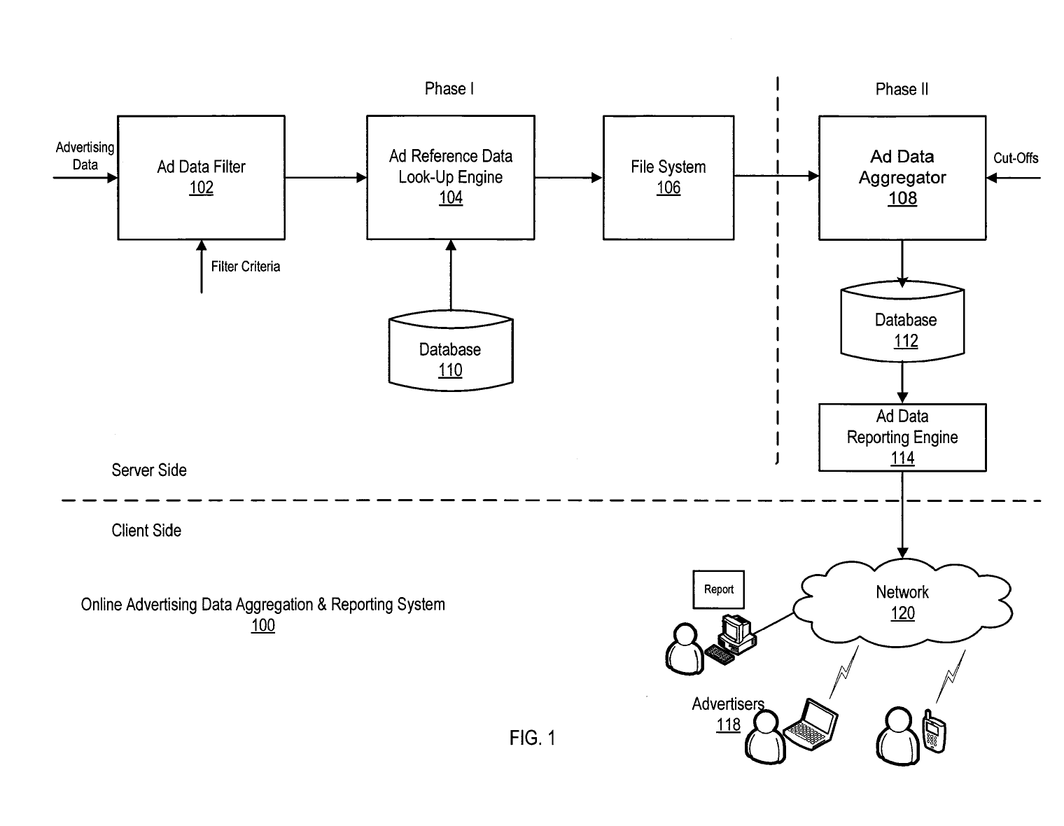

FIG. 1 is a block diagram illustrating an exemplary online advertising data aggregation and reporting system. An online advertising data aggregation and reporting system 100 may aggregate advertising data and generate reports based on the aggregated advertising data.

The raw advertising data that may be processed by the system 100 may include data relating to one or more parameters associated with one or more advertisements. In some implementations, the raw data includes data relating to advertisement impressions, advertisement click-throughs, and/or advertisement conversions. More generally, the raw advertising data may include statistical data regarding the performance of one or more advertisements.

In some implementations, the system 100 includes an ad data filter 102, an ad reference data look-up engine 104, a file system 106, an ad data aggregator 108, databases 110 and 112, and an ad data reporting engine 114. One or more advertisers 118 may submit requests for reports to and receive reports from the ad data reporting engine 114 through one or more networks 120. The one or more networks 120 may include, for example, local area networks, wide area networks, intranets, wired or wireless networks, the Internet, or combinations of one or more of these.

In some implementations, all of the received raw data are processed. In some other implementations, a sample subset of the raw data is processed. For example, it may be the case that only a sample subset of the raw data is filtered, enriched, and stored for aggregation. Alternatively, it may be the case that all of the received raw data may be filtered, but a sample of the filtered data is enriched and stored for aggregation.

An ad data filter 102 may filter raw advertising data based on one or more predefined filter criteria. The ad data filter 102 identifies the data that satisfies the predefined criteria and removes such data from the raw data set. The removed data may be saved for further use or permanently discarded. In one implementation, the ad data filter 102 includes criteria for filtering the raw data to a Universal Resource Locator (URL) or a domain level. That is, the filter 102 filters the data such that the filtered data provides information on a per-advertisement, per-URL or domain basis, where the URL or domain is a URL or domain where the advertisement was placed. In another implementation, the predefined criteria includes criteria relating to spam and/or click fraud. That is, the ad data filter 102 may filter raw advertising data to remove data that are determined to be potential spam or click fraud.

An ad reference data look-up engine 104 may optionally enrich filtered advertising data. In some implementations, the advertising data may be augmented with additional reference information relating to the advertisements with which the data are associated. For example, the advertising data may be enriched with data regarding the type of advertisement and other characteristics or properties associated with the advertisements to which the data is related. The ad reference data look-up engine 104 may retrieve information associated with an advertisement from a database 110 of advertisement information using advertisement identifiers. In one implementation, an advertisement identifier is a unique identifier assigned to an advertisement. The database 110 stores advertisement information. For an advertisement, the stored information may include, without limitation, the type of advertisement; keywords, regions, and/or demographics to which the advertisement is targeted; and so forth.

The filtered and enriched advertising data may be stored in a file system 106 or other data repository pending further processing. In one implementation, the file system 106 is the Google File System, which is described in Ghemawat et al, “The Google File System,” Proceedings of the 19th ACM Symposium on Operating Systems Principles (2003), the disclosure of which is hereby incorporated by reference herein.

An ad data aggregator 108 retrieves advertising data from the file system 106 and aggregates the advertising data. During the aggregation of the data, additional filters may be applied to the data. In some implementations, the additional filters include one or more predefined thresholds. The thresholds act as cut-offs to be applied against the advertising data. The cut-off thresholds serve to filter out data that may be considered insignificant. The removed data may be kept for re-processing or permanently discarded. For example, analyses may be performed on the removed data. The ad data aggregator 108 produces a reduced advertisement data set, which may be stored in a database 112.

An ad data reporting engine 114 may receive report requests from advertisers 118 through one or more networks 120. The ad data reporting engine 114 retrieves the pertinent data from the database 112, generates the reports from the retrieved data, and sends the reports to the advertisers 118 over the networks 120.

In one implementation, the reports generated by the ad data reporting engine 114 report advertising data at the URL or domain level. That is, for an advertisement, the report reports the performance of the advertisement for each URL or domain in which the advertisement was placed.

It should be appreciated that the system 100 described above is merely exemplary. Other implementations are possible. For example, in one implementation, the ad data filter 102 comes “after” the ad reference data look-up engine 104. That is, reference data is retrieved for the advertising data before the advertising data is filtered by the ad data filter 102. In another implementation, a data aggregator and a cut-off threshold engine take the place of the ad data aggregator 108 that performed both the aggregation of advertising data and the application of cut-off threshold. The data aggregator aggregates advertising data (which may be performed continuously), and stores the aggregated data in the file system 106. The cut-off threshold engine retrieves aggregated data from the file system 106 periodically and applies cut-off thresholds to the data. The resulting data may be stored in the database 112.

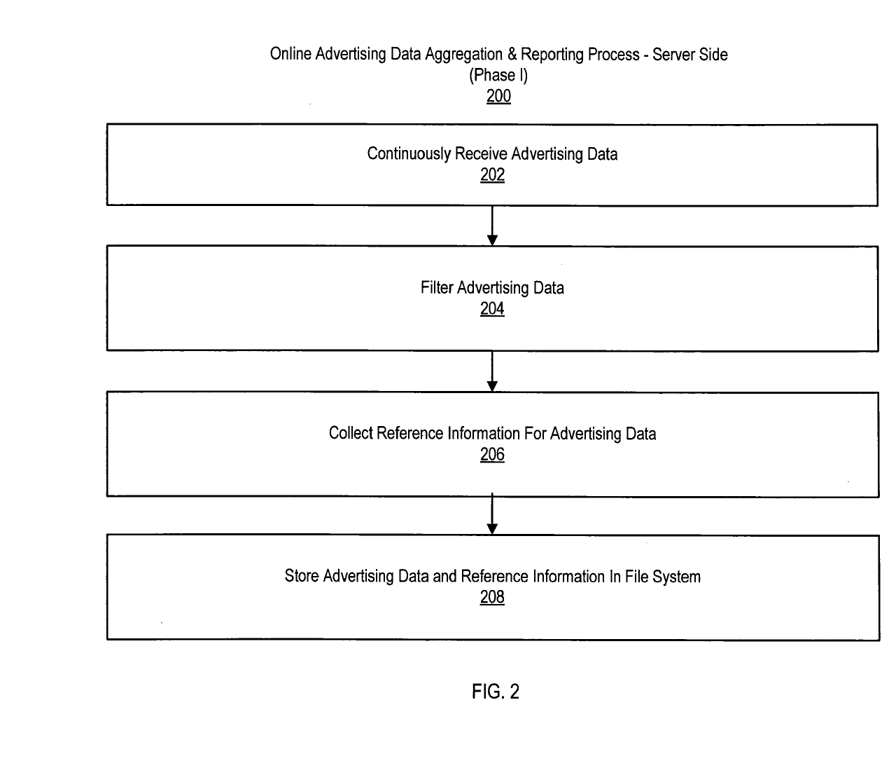

FIG. 2 is a flow diagram illustrating an exemplary process for collecting and processing advertising data.

In process flow 200, raw advertising data is received (202). The advertising data is filtered based on predefined criteria (204). For example, the advertisement data may be filtered, such that the data indicates the performance of advertisements at the URL/domain level. In some implementations, the advertising data may be filtered to remove data that is indicative of potential spam or click fraud, which may be misleading to advertisers as to the performance of their advertisements.

Optionally, reference information for advertising data is collected (206). The reference information augments the advertising data, providing additional information related to the advertisements with which the advertising data are associated. For example, the reference information may include the type of advertisement (e.g., video, text, banner, etc.). The reference information may be collected from an advertisements database, such as database 110 (FIG. 1). The filtered advertising data and reference information, if any, is stored in a file system or other data repository, such as file system 106 (208). In one implementation, the filtered data and reference information may be aggregated and the aggregated data is stored in the file system.

In some implementations, the advertising data is received continuously. That is, raw advertisement data may be received as events associated with the advertisements, such as impressions, click-throughs, and conversions, occur and data regarding such are provided. Process flow 200 may be performed continuously in order to process the continuous flow of advertising data.

In another implementation, the filtering operation (204) may be performed after the reference information for the advertising data is collected (206).

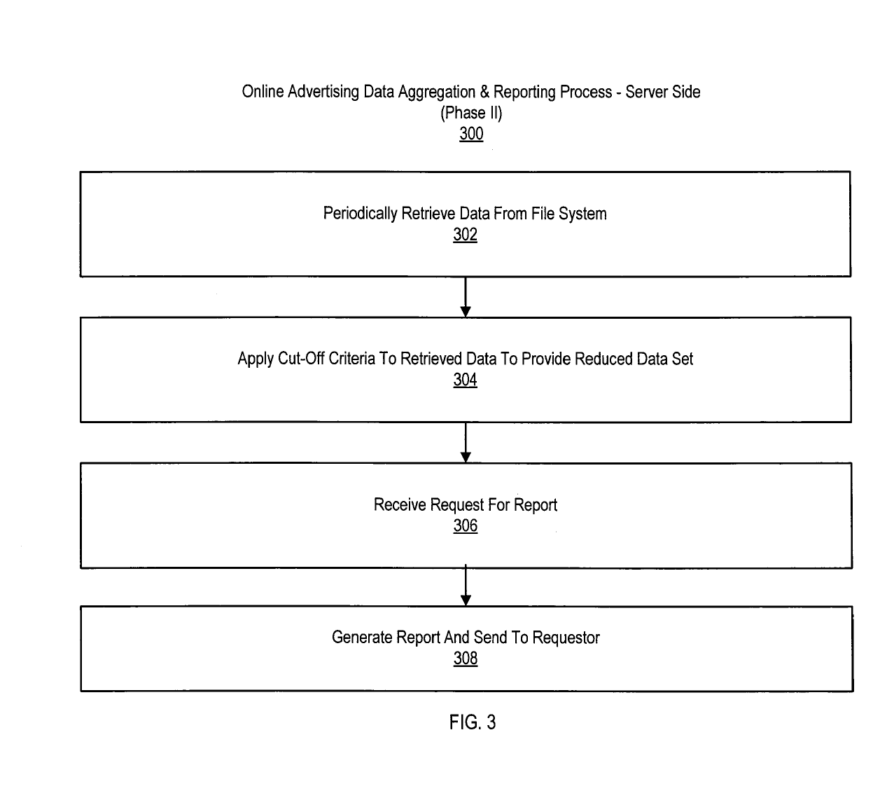

FIG. 3 is a flow diagram illustrating an exemplary process for reducing and reporting advertising data.

In process flow 300, data is retrieved from the file system (302). In some implementations, the data retrieved is for a particular time period. For example, data for the past 3 days may be retrieved. Retrieving a 3-day span of data may be helpful in accounting for time zone changes. In another implementation, data for the past day may be retrieved.

Threshold or cut-off criteria are applied to the retrieved data to produce a reduced data set (304). The threshold or cut-off criteria removes data that may be considered statistically insignificant for the purposes of reporting. Alternatively, the cut-off may be defined by the advertiser or the system to satisfy user or system requirements. In one implementation, the threshold or cut-off criteria may include a threshold of at least one click-through or one conversion for an advertisement. That is, if an advertisement placement at an URL/domain has no click-throughs or conversions within the relevant time period, the data for that advertisement placement for the relevant time period may be removed. In another implementation, the threshold or cut-off criteria may include a minimum number of impressions. That is, data for an advertisement placement that is not presented a sufficient number of times within the relevant time period may be removed. The reduced data set may be stored in a database, such as database 112, where it may be retrieved for inclusion in reports.

A request for a report is received (306). The request may be submitted by an advertiser who wishes to review the performance of his or her advertisements. Data relevant to the requested report is retrieved from a database. A report is generated from the retrieved data and sent to the requester (308). In one implementation, the report provides advertising data information at the URL or domain level. An advertiser may review the report and adjust their advertising campaign accordingly. For example, the advertiser may end placements of their advertisements on particular URLs or domains based on the report. In one implementation, the advertiser may modify their campaign manually. In another implementation, the advertiser may create rules that may be triggered based on the data included in the reports. The created rules may automatically modify the advertising campaign based on the data contained in the reports. For example, the advertiser may create a rule specifying that placements of an advertisement for a particular URL is stopped entirely, or a bid for advertisement space for the URL is modified, if the number of impressions for the placements at the URL, as reported in a report, is below a specified amount.

In one implementation, the aggregation operation (blocks 302-304) is performed periodically. For example, the data for each advertiser may be aggregated once daily.

In one implementation, the processing of the advertising data is performed in accordance with a technique described in Dean and Ghemawat, “MapReduce: Simplified Data Processing on Large Clusters,” Sixth Symposium on Operating System Design and Implementation (December 2004), the disclosure of which is hereby incorporated by reference herein.

In some implementations, process flows 200 and 300 may be considered as two phases of an advertising data aggregation process. In the first phase, corresponding to process flow 200, raw advertising data may be aggregated into URL/domain level advertising data and data that is indicative of potential spam or click fraud may be removed. In the second phase, corresponding to process flow 300, the URL/domain level advertising data is further aggregated to remove statistically insignificant data. The first phase may be performed continuously, and the second phase may be performed periodically.

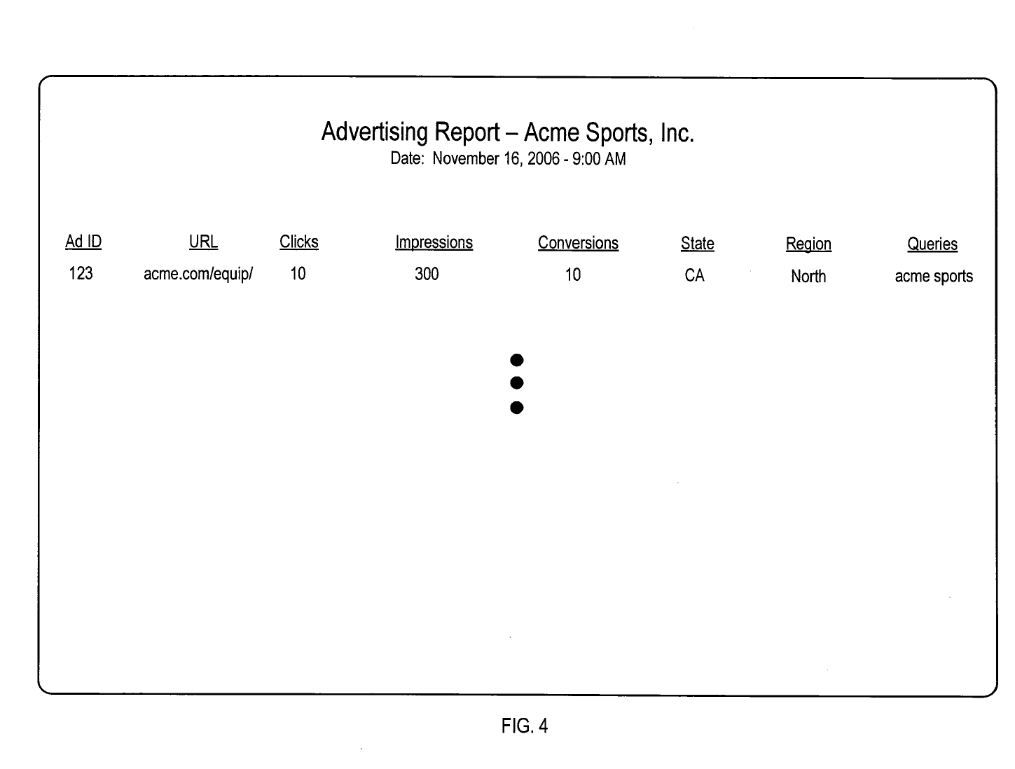

FIG. 4 illustrates an exemplary advertising data report. The report includes data associated with one or more advertisements placed by an advertiser. For example, for an advertisement listed in the report, the report may show a URL or domain at which the advertisement was placed, a geographic region associated with the advertisement or with the placement, and queries that triggered impressions of the advertisement. The report may include the counts of click-throughs, impressions, and conversions for that placement. In one implementation, the counts of click-throughs, impressions, and conversions in a report are for a predefined time period, e.g., a three-day span. The report may indicate the time period for which the reported data is applicable.

In the example report illustrated in FIG. 4, advertising data for the advertiser “Acme Sports, Inc.” is presented. The data shown is for the placement of an advertisement identified by the Ad_ID “123” with the URL “acme.com/equip.” That placement had 300 impressions, 10 click-throughs, and 10 conversions. The placement is targeted to the state “California” and the region “North.” Queries that triggered impressions of the advertisement include “acme sports.”

It should be appreciated that the example report shown in FIG. 4 is merely exemplary. An advertising data report may include more or less data than that shown, and alternative reporting formats may be used.

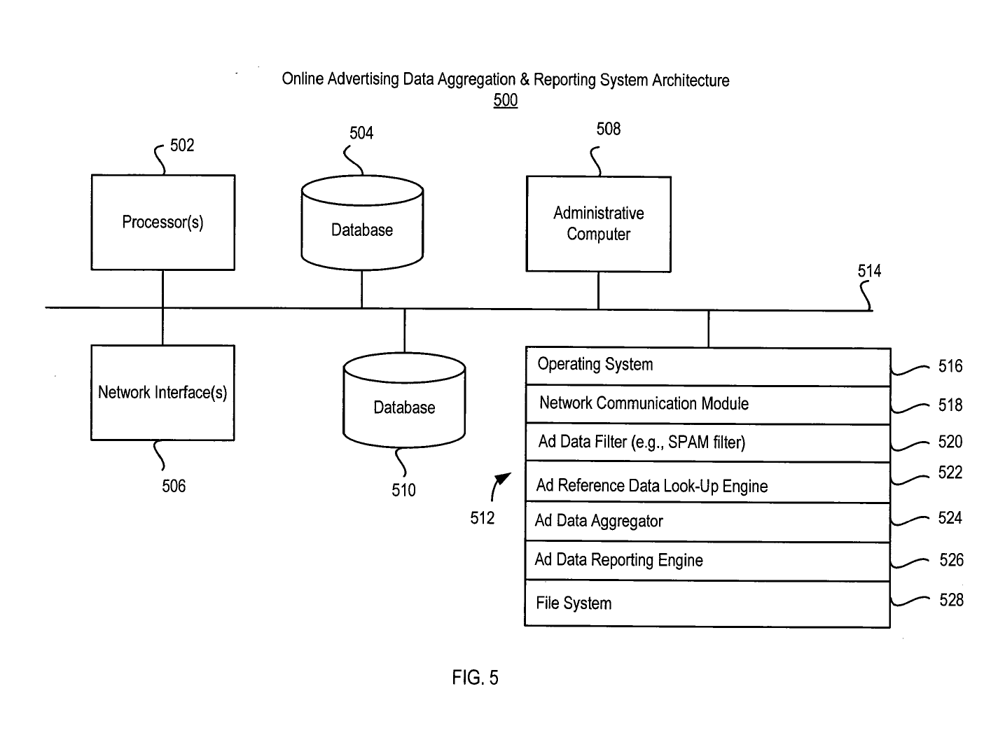

FIG. 5 is a block diagram illustrating an exemplary system architecture for an online advertising data aggregation and reporting system. The system architecture 500 includes one or more processors 502, one or more network or communication interfaces 504, databases 504 and 510, an administrative computer 508, memory 512, and a data bus 514 interconnecting these components.

The administrative computer 508 may include input devices, such as a keyboard and mouse, and output devices, such as a display (not shown). From the administrative computer 508, an administrative computer may administer the aggregation and reporting system.

Databases 504 and 510 may store advertisement reference data and aggregated advertising data, respectively. The advertisement reference data includes various information associated with advertisements, such as the type of advertisement, keywords to which the advertisements are targeted, and so forth. The aggregated data may be presented to advertisers in reports generated by the system.

Memory or computer readable medium 512 may store an operating system 516 for performing system functions, a network communication module 518 for communicating with other computers or devices through one or more networks, an ad data filter 520 (e.g., spam filter) for filtering advertising data, an ad reference data look-up engine 522 for retrieving advertisement reference data from database 504, an ad data aggregator 524 for aggregating advertising data and applying cut-off criteria to the advertising data, an ad data reporting engine 526 for receiving requests for advertising data reports, generating such reports, and sending such reports to the requestors, and a file system 528 for storing filtered advertising data pending further processing.

The disclosed and other embodiments and the functional operations described in this specification can be implemented in digital electronic circuitry, or in computer software, firmware, or hardware, including the structures disclosed in this specification and their structural equivalents, or in combinations of one or more of them. The disclosed and other embodiments can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the disclosed embodiments can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed embodiments can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of what is disclosed here, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what being claims or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments have been described. Other embodiments are within the scope of the following claims.

What is claimed is:

1. A computer-implemented method comprising:
gathering statistical data relating to one or more parameters associated with an advertisement, including filtering the statistical data to a Universal Resource Locator (URL) or domain level; and
delivering the statistical data to an advertiser.

2. The method of claim 1, wherein the one or more parameters comprise at least one of click-throughs, impressions, or conversions.

3. The method of claim 1, wherein gathering statistical data further comprises filtering the statistical data to remove spam.

4. The method of claim 1, wherein gathering statistical data further comprises enriching the statistical data with reference information associated with the advertisement.

5. A computer-readable medium having stored thereon instructions, which, when executed by a processor, causes the processor to perform the operations of:
gathering statistical data relating to one or more parameters associated with an advertisement, including filtering the statistical data to a Universal Resource Locator (URL) or domain level; and
delivering the statistical data to an advertiser.

6. A system, comprising:
one or more processors; and
one or more sets of instructions which, when executed by the one or more processors, causes the one or more processors to perform the operations of:
gathering statistical data relating to one or more parameters associated with an advertisement, including filtering the statistical data to a Universal Resource Locator (URL) or domain level; and
delivering the statistical data to an advertiser.

7. A system, comprising:
means for gathering statistical data relating to one or more parameters associated with an advertisement, including means for filtering the statistical data to a Universal Resource Locator (URL) or domain level; and
means for delivering the statistical data to an advertiser.

8. A computer-implemented method, comprising:
aggregating statistical data relating to one or more parameters associated with an advertisement;
evaluating the statistical data, including applying a filter to the statistical data; and
delivering the filtered statistical data to an advertiser.

9. The method of claim 8, wherein the one or more parameters comprise at least one of click-throughs, impressions, or conversions.

10. The method of claim 8, wherein aggregating statistical data comprises continuously aggregating statistical data relating to one or more parameters associated with an advertisement.

11. The method of claim 8, wherein evaluating the statistical data comprises periodically evaluating the statistical data.

12. The method of claim 8, wherein periodically evaluating the statistical data comprises periodically evaluating the statistical data at a frequency that is greater than a frequency associated with the aggregating.

13. The method of claim 8, wherein applying the filter comprises applying one or more thresholds to the statistical data.

14. The method of claim 13, wherein the one or more thresholds comprise at least one of a number of click-throughs, a number of impressions, or a number of conversions.

15. The method of claim 8, wherein aggregating the statistical data comprises aggregating a sample subset of a raw statistical data.

16. The method of claim 8, wherein aggregating the statistical data comprises filtering the statistical data to a URL or domain level.

17. The method of claim 8, wherein aggregating the statistical data comprises retrieving and appending information associated with the advertisement to the filtered statistical data.

18. A computer-readable medium having stored thereon instructions, which, when executed by a processor, causes the processor to perform the operations of:
aggregating statistical data relating to one or more parameters associated with an advertisement;
evaluating the statistical data, including applying a filter to the statistical data; and
delivering the filtered statistical data to an advertiser.

19. A system, comprising:
one or more processors; and
one or more sets of instructions which, when executed by the one or more processors, causes the one or more processors to perform the operations of:
aggregating statistical data relating to one or more parameters associated with an advertisement;
evaluating the statistical data, including applying a filter to the statistical data; and
delivering the filtered statistical data to an advertiser.

20. A system, comprising:
means for aggregating statistical data relating to one or more parameters associated with an advertisement;
means for evaluating the statistical data, including means for applying a filter to the statistical data; and
means for delivering the filtered statistical data to an advertiser.

21. A computer-implemented method, comprising:
receiving a report comprising statistical data associated with an advertisement placement in an advertising campaign, the statistical data filtered to a URL or domain level; and
modifying the advertising campaign in accordance with the report.

22. The method of claim 21, further comprising, before receiving the report, requesting the report.

23. The method of claim 21, wherein modifying the advertising campaign comprises canceling advertisement placements to one or more URLs or domains.

24. The method of claim 21, further comprising providing one or more inputs, the one or more inputs comprising thresholds applied to the statistical data.

25. The method of claim 21, further comprising providing a URL or domain preference with respect to the statistical data.

26. A computer-readable medium having stored thereon instructions, which, when executed by a processor, causes the processor to perform the operations of:
receiving a report comprising statistical data associated with an advertisement placement in an advertising campaign, the statistical data filtered to a URL or domain level; and
modifying the advertising campaign in accordance with the report.

27. A system, comprising:
one or more processors; and
one or more sets of instructions which, when executed by the one or more processors, causes the one or more processors to perform the operations of:
receiving a report comprising statistical data associated with an advertisement placement in an advertising campaign, the statistical data filtered to a URL or domain level; and
modifying the advertising campaign in accordance with the report.

28. A system, comprising:
means for receiving a report comprising statistical data associated with an advertisement placement in an advertising campaign, the statistical data filtered to a URL or domain level; and
means for modifying the advertising campaign in accordance with the report.
